(19) United States
(12) Patent Application Publication
(10) Pub. No.: US 2026/0212427 A1
(43) Pub. Date: Jul. 23, 2026

(54) SYSTEM AND METHOD FOR PHASE SHIFTED OPERATION TO ACHIEVE OVERALL LOWER PEAK POWER

(71) Applicant: GE Precision Healthcare LLC, Waukesha, WI (US)

(72) Inventor: Goutam Maji, Bangalore (IN)

(21) Appl. No.: 19/032,680

(22) Filed: Jan. 21, 2025

(51) Int. Cl. G06Q 50/06; G06Q 10/0631; H02J 3/00; H05G 1/10; H02J 105/12; H02J 105/52

(52) U.S. Cl. CPC G06Q 50/06; G06Q 10/0631; H02J 3/003; H05G 1/10; H02J 2105/12; H02J 2105/52

(57) ABSTRACT

A computer-implemented method for phase shifted operation of X-ray imaging systems includes monitoring, via a processing system, a status of a plurality of X-ray imaging systems coupled to an electrical grid. The computer-implemented method also includes facilitating, via the processing system, operation of the plurality of X-ray imaging systems in a phase shifted manner so that only a single X-ray imaging system of the plurality of X-ray imaging systems conducts an X-ray scan at a time so that total peak power demand from the plurality of X-ray imaging systems at the time of the X-ray scan does not exceed a peak power demand of the single X-ray imaging system.

### BACKGROUND

The subject matter disclosed herein relates to imaging systems and, more particularly, to a system and method for phase shifted operation to achieve overall lower peak power.

Non-invasive imaging technologies allow images of the internal structures or features of a patient to be obtained without performing an invasive procedure on the patient. In particular, such non-invasive imaging technologies rely on various physical principles, such as the differential transmission of X-rays through the target volume or the reflection of acoustic waves, to acquire data and to construct images or otherwise represent the observed internal features of the patient.

For example, in computed tomography (CT) and other X-ray based imaging technologies, X-ray radiation spans a subject of interest, such as a human patient, and a portion of the radiation impacts a detector where the image data is collected. In digital X-ray imaging systems a photodetector produces signals representative of the amount or intensity of radiation impacting discrete pixel regions of a detector surface. The signals may then be processed to generate an image that may be displayed for review. In CT imaging systems, a detector array, including a series of detector elements, produces similar signals through various positions as a gantry is displaced around a patient.

A typical CT imaging system draws six to nine times peak power over its average power during the X-ray scans. Hence, if there are multiple CT imaging systems conducting X-ray scans at the same time, there will be a huge amount of peak power that will be drawn from the utility grid, which is very difficult for the utility grid to handle due to the sudden peak power demand. In addition, this is not economical for both the utility grid and the user of the CT system as they must pay high peak demand charges.

### SUMMARY

Certain embodiments commensurate in scope with the originally claimed subject matter are summarized below. These embodiments are not intended to limit the scope of the claimed subject matter, but rather these embodiments are intended only to provide a brief summary of possible forms of the subject matter. Indeed, the subject matter may encompass a variety of forms that may be similar to or different from the embodiments set forth below.

In one embodiment, a computer-implemented method for phase shifted operation of X-ray imaging systems is provided. The computer-implemented method includes monitoring, via a processing system, a status of a plurality of X-ray imaging systems coupled to an electrical grid. The computer-implemented method also includes facilitating, via the processing system, operation of the plurality of X-ray imaging systems in a phase shifted manner so that only a single X-ray imaging system of the plurality of X-ray imaging systems conducts an X-ray scan at a time so that total peak power demand from the plurality of X-ray imaging systems at the time of the X-ray scan does not exceed a peak power demand of the single X-ray imaging system.

In another embodiment, a system for phase shifted operation of X-ray imaging systems is provided. The system includes a memory encoding processor-executable routines. The system also includes a processing system including one or more processors and configured to access the memory and to execute the processor-executable routines, wherein the processor-executable routines, when executed by the processing system, cause the processing system to perform actions. The actions include monitoring a status of a plurality of X-ray imaging systems coupled to an electrical grid. The actions also include facilitating operation of the plurality of X-ray imaging systems in a phase shifted manner so that only a single X-ray imaging system of the plurality of X-ray imaging systems conducts an X-ray scan at a time so that total peak power demand from the plurality of X-ray imaging systems at the time of the X-ray scan does not exceed a peak power demand of the single X-ray imaging system.

In a further embodiment, a non-transitory computer-readable medium is provided. The non-transitory computer-readable medium includes processor-executable code that, when executed by a processing system including one or more processors, causes the processing system to perform actions. The actions include monitoring a status of a plurality of X-ray imaging systems coupled to an electrical grid. The actions also include facilitating operation of the plurality of X-ray imaging systems in a phase shifted manner so that only a single X-ray imaging system of the plurality of X-ray imaging systems conducts an X-ray scan at a time so that total peak power demand from the plurality of X-ray imaging systems at the time of the X-ray scan does not exceed a peak power demand of the single X-ray imaging system.

### BRIEF DESCRIPTION OF THE DRAWINGS

These and other features, aspects, and advantages of the disclosed subject matter will become better understood when the following detailed description is read with reference to the accompanying drawings in which like characters represent like parts throughout the drawings, wherein:

FIG. 1 is a combined pictorial view and block diagram of a computed tomography (CT) imaging system as discussed herein;

FIG. 2 is a block diagram for a medical imaging load, in accordance with aspects of the present disclosure;

FIG. 3 is a schematic diagram of a process for phase shifted operation of X-ray imaging systems, in accordance with aspects of the present disclosure;

FIG. 4 is a schematic diagram illustrating co-location of X-ray imaging systems, in accordance with aspects of the present disclosure;

FIG. 5 is a schematic diagram illustrating X-ray imaging systems remotely located from each other, in accordance with aspects of the present disclosure;

FIG. 6 depicts graphs illustrating power usage of two different CT imaging systems (e.g., during random operation);

FIG. 7 depicts graphs illustrating power usage of two different CT imaging systems (e.g., during phase shifted operation), in accordance with aspects of the present disclosure;

FIG. 8 is a flowchart of a method for phase shifted operation of X-ray imaging systems, in accordance with aspects of the present disclosure;

FIG. 9 is a flowchart of another method for phase shifted operation of X-ray imaging systems, in accordance with aspects of the present disclosure;

FIG. 10 is a schematic diagram of a single power distribution unit coupled to multiple X-ray imaging systems, in accordance with aspects of the present disclosure; and

FIG. 11 is a schematic diagram of a respective power distribution unit coupled to respective X-ray imaging systems, in accordance with aspects of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers’ specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present subject matter, the articles “a,” “an,” “the,” and “said” are intended to mean that there are one or more of the elements. The terms “comprising,” “including,” and “having” are intended to be inclusive and mean that there may be additional elements other than the listed elements. Furthermore, any numerical examples in the following discussion are intended to be non-limiting, and thus additional numerical values, ranges, and percentages are within the scope of the disclosed embodiments.

While aspects of the following discussion are provided in the context of medical imaging, it should be appreciated that the disclosed techniques are not limited to such medical contexts. Indeed, the provision of examples and explanations in such a medical context is only to facilitate explanation by providing instances of real-world implementations and applications. However, the disclosed techniques may also be utilized in other contexts, such as image reconstruction for non-destructive inspection of manufactured parts or goods (i.e., quality control or quality review applications), and/or the non-invasive inspection of packages, boxes, luggage, and so forth (i.e., security or screening applications). In general, the disclosed techniques may be useful in any imaging or screening context or image processing or photography field where an X-ray source is utilized.

The present disclosure provides embodiments for phase-shifted operation of medical imaging systems. The medical imaging system may be an X-ray source configured to emit X-rays. For example, the medical imaging system may be a computed tomography imaging system, a fluoroscopy imaging system, an interventional imaging system, and a radiography imaging system (i.e., conventional imaging system including a mammography imaging system). The disclosed system and method enable phase shifted operation of X-ray imaging systems (that are connected to the same electrical grid) by which the X-ray imaging systems can run without increasing peak demand. In particular, the disclosed system and method enable multiple X-ray imaging systems (or other equipment) to run without crossing individual peak power limit by operating the X-ray imaging systems in a passed manner (i.e., one at a time or in a time-multiplexed manner). Specifically, multiple X-ray imaging systems that are connected to the same utility grid/transformer shall be operated in a time-multiplexed manner such that only one medical imaging system can conduct an X-ray scan at a same time, while the other X-ray imaging systems are in stand-by mode (i.e., power saving mode). Upon the first X-ray imaging system completing the X-ray scan, the next X-ray imaging system can conduct an X-ray scan.

The disclosed embodiments enable a healthcare provider (e.g., hospital) having multiple X-ray imaging systems to reduce their overall load demand. The disclosed embodiments enable a healthcare provider to add an additional medical imaging system without adding additional power demand from the utility. The disclosed embodiments enable a single power distribution unit to power multiple X-ray imaging systems, which enables a healthcare provider to reduce cost associated with power distribution units. The disclosed embodiments enable receiving government incentive by participating in a time-multiplexed operation which helps the utility grid to operate in a more efficient way. The disclosed embodiments provide a lower footprint by eliminating an additional distribution transformer, diesel generator set, system uninterruptible power supply, and/or power distribution unit.

The disclosed systems and methods include monitoring a status of a plurality of X-ray imaging systems coupled to an electrical grid. The disclosed systems and methods also include facilitating operation of the plurality of X-ray imaging systems in a phase shifted manner so that only a single X-ray imaging system of the plurality of X-ray imaging systems conducts an X-ray scan at a time so that total peak power demand from the plurality of X-ray imaging systems at the time of the X-ray scan does not exceed a peak power demand of the single X-ray imaging system.

In certain embodiments, the disclosed systems and methods include keeping other X-ray imaging systems of the plurality of X-ray imaging systems in a stand-by mode while the single X-ray imaging system is conducting the X-ray scan. In certain embodiments, the disclosed systems and methods include enabling another X-ray imaging system of the plurality of X-ray imaging systems to conduct a respective X-ray scan once the single X-ray imaging system completes the X-ray scan.

In certain embodiments, the plurality of X-ray imaging systems is co-located in a same building. In certain embodiments, the plurality of X-ray imaging systems is configured to communicate with each other via respective operating consoles of the plurality of X-ray imaging systems to facilitate operation in the phase shifted manner. In certain embodiments, at least two X-ray imaging systems of the plurality of X-ray imaging systems utilize a common power distribution unit.

In certain embodiments, at least some X-ray imaging systems (e.g., two or more) of the plurality of X-ray imaging systems are located in different geographical locations. In certain embodiments, the plurality of X-ray imaging systems is configured to communicate with each other via a communication network to facilitate operation in the phase shifted manner.

In certain embodiments, the systems and methods include receiving communications from one or more of the plurality of X-ray imaging systems of an intent to conduct a respective X-ray scan. In certain embodiments, the systems and methods include scheduling respective X-ray scans of the plurality of X-ray imaging systems in the phase shifted manner.

The disclosed embodiments include a non-transitory computer-readable medium that includes processor-executable code that, when executed by a processing system including one or more processors, causes the processing system to perform actions. The actions include monitoring a status of a plurality of X-ray imaging systems coupled to an electrical grid. The actions also include facilitating operation of the plurality of X-ray imaging systems in a phase shifted manner so that only a single X-ray imaging system of the plurality of X-ray imaging systems conducts an X-ray scan at a time so that total peak power demand from the plurality of X-ray imaging systems at the time of the X-ray scan does not exceed a peak power demand of the single X-ray imaging system. In certain embodiments, the processor-executable code, when executed by the processing system, further causes the processing system to keep other X-ray imaging systems of the plurality of X-ray imaging systems in a stand-by mode while the single X-ray imaging system is conducting the X-ray scan.

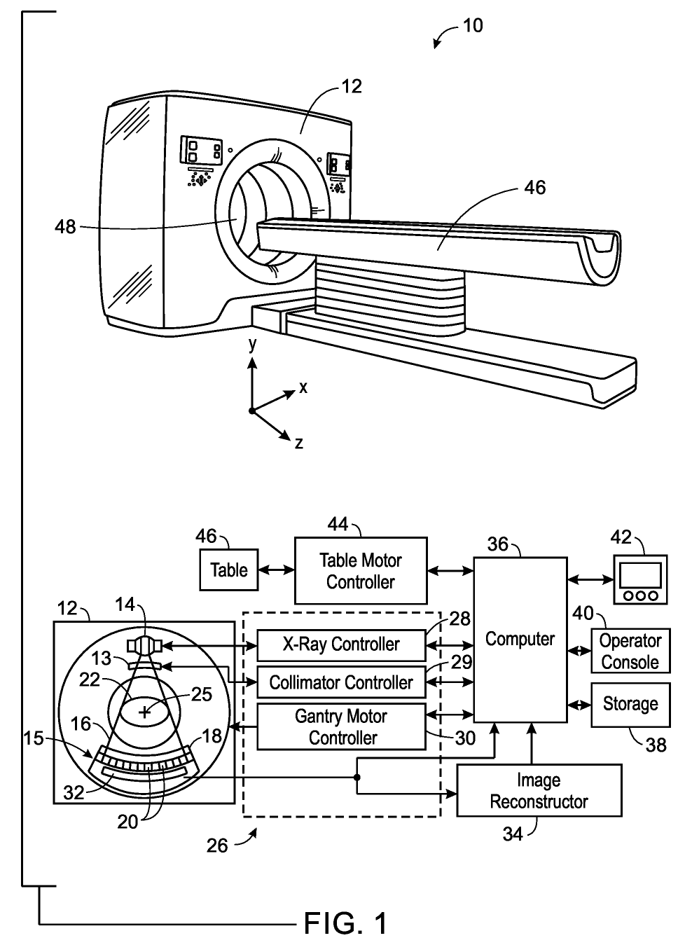

With the preceding in mind and referring to FIG. 1, a computed tomography (CT) imaging system 10 is shown, by way of example. The CT imaging system 10 includes a gantry 12. The gantry 12 has an X-ray source 14 that projects a beam of X-rays 16 toward a detector assembly 15 on the opposite side of the gantry 12. The X-ray source 14 projects the beam of X-rays 16 through a pre-patient collimator assembly 13 that determines the size and shape of the beam of X-rays 16. The detector assembly 15 includes a collimator assembly 18 (a post-patient collimator assembly), a plurality of detector modules 20 (e.g., detector elements or sensors), and data acquisition systems (DAS) 32. The plurality of detector modules 20 detect the projected X-rays that pass through a subject or object 22 being imaged, and DAS 32 converts the data into digital signals for subsequent processing. Each detector module 20 in a conventional system produces an analog electrical signal that represents the intensity of an incident X-ray beam and hence the attenuated beam as it passes through the subject or object 22. During a scan to acquire X-ray projection data, gantry 12 and the components mounted thereon rotate about a center of rotation 25 (e.g., isocenter) so as to collect attenuation data from a plurality of view angles relative to the imaged volume.

Rotation of gantry 12 and the operation of X-ray source 14 are governed by a control system 26 of CT imaging system 10. Control system 26 includes an X-ray controller 28 that provides power and timing signals to an X-ray source 14, a collimator controller 29 that controls a length and a width of an aperture of the pre-patient collimator 13 (and, thus, the size and shape of the beam of X-rays 16), and a gantry motor controller 30 that controls the rotational speed and position of gantry 12. An image reconstructor 34 receives sampled and digitized X-ray data from DAS 32 and performs high-speed image reconstruction. The reconstructed image is applied as an input to a computer 36, which stores the image in a storage device 38. Computer 36 also receives commands and scanning parameters from an operator via console 40. An associated display 42 allows the operator to observe the reconstructed image and other data from computer 36. The operator supplied commands and parameters are used by computer 36 to provide control signals and information to DAS 32, X-ray controller 28, collimator controller 29, and gantry motor controller 30. In addition, computer 36 operates a table motor controller 44, which controls a motorized table 46 (e.g., patient table) to position subject 22 and gantry 12. Particularly, table 46 moves portions of subject 22 through a gantry opening or bore 48.

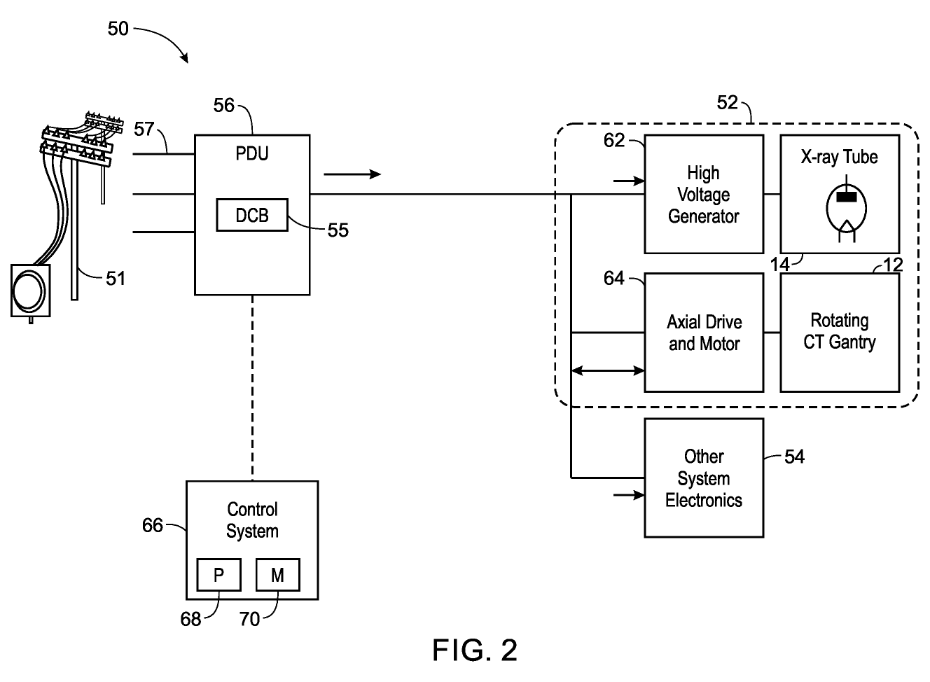

FIG. 2 is discussed in the context of a computed tomography imaging system. As noted above, the disclosed embodiments can be utilized with other medical imaging systems having an X-ray source (e.g., a fluoroscopy imaging system and a radiography imaging system). FIG. 2 is a power supply system 50 that provides power to one or more medical imaging loads 52 (e.g., computed tomography imaging system 10 of FIG. 1) and/or other electronics 54 (e.g., computer 36, console 40, and/or display 42 for computed tomography imaging system 10). A main alternating current (AC) power source (e.g., from an electrical grid) may provide power (e.g., single phase or polyphase AC power such as 3-phase AC power) via an AC power line 51 to a power distribution unit (PDU) 56 via an AC input 57 (e.g., single phase or 3-phase power plug). The power distribution unit 56 may convert the AC power to DC power and provide the DC power to the medical imaging loads 52 and/or other electronics 54. In certain embodiments, the power distribution unit 56 also provides AC power to the medical imaging loads 52 and/or other electronics 54.

In certain embodiments, the power distribution unit 56 includes an active rectifier. The power distribution unit 56 is disposed outside a stationary portion of the CT imaging scanner of the system 10. Power may be transmitted from the stationary portion to a rotating portion of the CT imaging scanner of the system 10 via a slip ring or wirelessly. In certain embodiments, power distribution unit 56 includes a digital control board (DCB) 55 for online power monitoring. The digital control board 55 is also configured for performing diagnostics offline or remotely if there is any issue on the power distribution unit 56 or with the active rectifier. The digital control board 55 controls operation of the active rectifier. In certain embodiments, the active rectifier is communicatively coupled to a controller (e.g., controller for gantry) on the system 10 to enable the controller both to monitor and to diagnose any issues with the power distribution unit 56. In certain embodiments, the active rectifier is communicatively coupled to the controller via an Ethernet connection (or other type of communication interface such as serial or controller area network). The system 10 may monitor and/or report on different parameters of the power supply system 50 (e.g., power distribution unit 56 including the active rectifier). These parameters may include input voltage, input current, transformer temperature, PDU ambient temperature, all board rail voltages, and other parameters. These parameters may be communicated (e.g., wired or wirelessly) from the controller to the host computer 36 and/or console 40. Besides monitoring, diagnostics may be performed on the power distribution unit 56 by the controller (via the communication interface).

While one or more medical imaging loads 52 are described below with respect to loads for a computed tomography (CT) system, it will be appreciated that embodiments are applicable for use with other imaging configurations. The one or more medical imaging loads 52 may include a high voltage generator 62 coupled to the power distribution unit 56. The high voltage generator 62 may provide power to an X-ray tube 14, of the computed tomography (CT) imaging system 10. The X-ray tube 14 may emit X-ray beams toward a subject or object, such as a patient. The beam, after being attenuated by the subject, impinges upon an array of radiation detector. The intensity of the attenuated beam radiation received at the detector array may be dependent upon the attenuation of the X-ray beam by the subject. Each detector element of the detector array produces a separate electrical signal indicative of the attenuated beam received by each detector element. The electrical signals are transmitted to a data processing system for analysis which produces an image. Further, the X-ray source and the detector array may be rotated, via an axial drive and motor 64, about the gantry 12 within an imaging plane and around the subject or object. When the gantry 12 is rotated, it converts the power from the power distribution unit 56 to rotational kinetic energy via the motor 64.

The power distribution unit 56 may be controlled by a control system 66 having a FPGA or processor 68 or multiple FPGA or multiple processors and memory 70. In certain embodiments, the control system 66 is part of the power distribution unit 56. The processor 68 may be operatively coupled to the memory 70 to execute instructions for carrying out the presently disclosed techniques. These instructions may be encoded in programs or code stored in a tangible non-transitory computer-readable medium, such as the memory 70 and/or other storage. The processor 68 may be a general purpose processor (e.g., processor of a desktop/laptop computer), system-on-chip (SoC) device, or application-specific integrated circuit, or some other processor configuration. The memory 70, in the embodiment, includes a computer readable medium, such as, without limitation, a hard disk drive, a solid state drive, diskette, flash drive, a compact disc, a digital video disc, random access memory (RAM), and/or any suitable storage device that enables the processor 68 to store, retrieve, and/or execute instructions and/or data. The memory 70 may include one or more local and/or remote storage devices. The processor 68 may control components of the power distribution unit 56 to provide power to the one or more medical imaging loads 52.

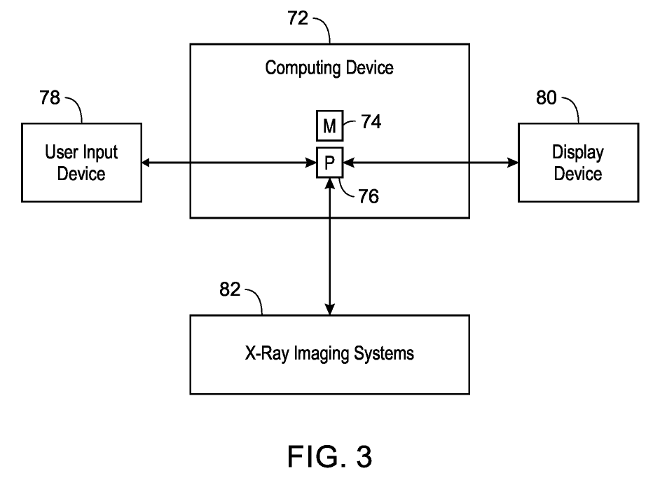

FIG. 3 is a schematic diagram of a computing device 72 for performing the disclosed techniques herein. In particular, the computing device 72 is utilized for phase shifted operation (e.g., via scheduling) of X-ray imaging systems. The computing device 72 may be computer 36 of the CT imaging system 10 in FIG. 1 or a remote computing device. In certain embodiments, the computing device 72 may be a remote cloud-based processing system.

The computing device 72 includes a memory 74 and a processing system 76. In some embodiments, the processing system 76 may include one or more general purpose processors, one or more application specific integrated circuits, one or more field programmable gate arrays, or the like. Additionally, the memory 74 may be any tangible, non-transitory, computer readable medium that is capable of storing instructions executable by the processing system 76 and/or data that may be processed by the processing system 76. In other words, the memory 74 may include volatile memory, such as random-access memory, or non-volatile memory, such as hard disk drives, read only memory, optical disks, flash memory, and the like.

The computing device 72 is communicatively coupled with a user input device 78 and a display device 80. The user input device 78 may include one or more of a touchscreen, a keyboard, a mouse, a trackpad, a motion sensing camera, or other device configured to enable a user to interact with the computing device 72. The display device 80 may include one or more display devices utilizing virtually any type of technology. In some embodiments, the display device 80 may include a computer monitor. The display device 80 may be combined with the processing system 76, the non-transitory memory 74, and/or the user input device 78 in a shared enclosure, or may be peripheral display devices and may include a monitor, touchscreen, projector, or other display device known in the art, which may enable a user to view data and/or interact with various data stored in the non-transitory memory 74.

The computing device 72 is communicatively coupled to a plurality of X-ray imaging systems 82. In certain embodiments, the plurality of X-ray imaging systems 82 are of a same imaging modality. In certain embodiments, one or more of the X-ray imaging systems 82 may be of a different imaging modality. The X-ray imaging systems 82 may be a computed tomography imaging system (e.g., CT imaging system 10 in FIG. 1), a fluoroscopy imaging system, an interventional imaging system, and a radiography imaging system (i.e., conventional imaging system including a mammography imaging system).

As described in greater detail below, the processing system 76 is configured to monitor a status of a plurality of X-ray imaging systems 82 coupled to an electrical grid. In certain embodiments, the plurality of X-ray imaging systems 82 is co-located in a same building. In certain embodiments, at least two X-ray imaging systems 82 of the plurality of X-ray imaging systems 82 utilize a common power distribution unit. In certain embodiments, at least some X-ray imaging systems 82 of the plurality of X-ray imaging systems 82 are located in different geographical locations. The processing system 76 is also configured to facilitate operation of the plurality of X-ray imaging systems 82 in a phase shifted manner so that only a single X-ray imaging system 82 of the plurality of X-ray imaging systems 82 conducts an X-ray scan at a time so that total peak power demand from the plurality of X-ray imaging systems 82 at the time of the X-ray scan does not exceed a peak power demand of the single X-ray imaging system 82. In certain embodiments, the plurality of X-ray imaging systems 82 is configured to communicate with each other via respective operating consoles of the plurality of X-ray imaging systems 82 to facilitate operation in the phase shifted manner. In certain embodiments, the plurality of X-ray imaging systems 82 is configured to communicate with each other via a communication network to facilitate operation in the phase shifted manner. By operating in the phased shifted manner, multiple X-ray imaging systems 82 (or other equipment) can run without crossing individual peak power limit. In particular, the multiple X-ray imaging systems 82 (connected to the same grid) can run without increasing the peak demand. Operation in the phase shifted manner is operating the multiple X-ray imaging systems 82 in a passed manner (i.e., one at a time or in a time-multiplexed manner).

The processing system 76 is configured to receive communications from one or more of the plurality of X-ray imaging systems 82 of an intent to conduct a respective X-ray scan . The processing system 76 is also configured to schedule respective X-ray scans of the plurality of X-ray imaging systems 82 in the phase shifted manner. In certain embodiments, the respective X-ray scans may be scheduled in the order that the communications of an intent to conduct an X-ray scan are received. In certain embodiments, the respective X-ray scan may be scheduled by priority. For example, an X-ray scan for an emergency case (e.g., life-threatening situation) may be given priority over a non-emergency case (e.g., non-life-threatening situation). The respective X-ray scans are scheduled in the phase shifted manner so that they operate so that only a single X-ray imaging system of the plurality of X-ray imaging systems conducts an X-ray scan at a time so that total peak power demand from the plurality of X-ray imaging systems at the time of the X-ray scan does not exceed a peak power demand of the single X-ray imaging system.

The processing system 76 is also configured, while operating in the phase shifted manner, to conduct an X-ray scan with the single X-ray imaging system while keeping the other X-ray imaging systems of the plurality of X-ray imaging systems in a stand-by mode while the single X-ray imaging system is conducting the X-ray scan. The processing system 76 is also configured to enable another X-ray imaging system of the plurality of X-ray imaging systems to conduct a respective X-ray scan once the single X-ray imaging system completes the X-ray scan.

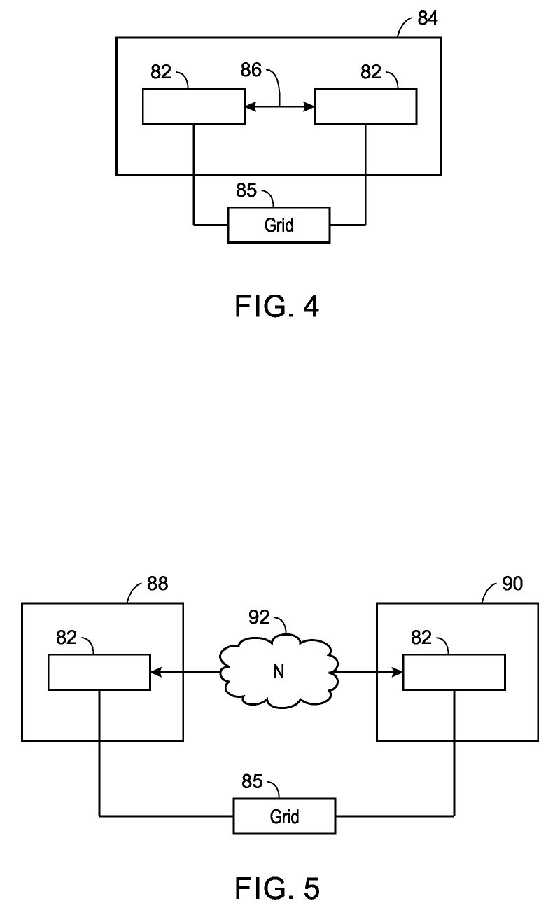

FIG. 4 is a schematic diagram illustrating co-location of X-ray imaging systems 82. As depicted, the X-ray imaging systems 82 are co-located in a same building 84. Each X-ray imaging system 82 is connected to the same electrical grid 85. In certain embodiments, more than X-ray imaging system 82 may share a power distribution unit. Each of the X-ray imaging systems 82 may respectively communicate with each other via their respective operating consoles and/or the computing device 72 in FIG. 3 as indicated by arrow 86 to enable phase shifted operation of X-ray imaging systems 82 so that only a single X-ray imaging system 82 of the plurality of X-ray imaging systems 82 conducts an X-ray scan at a time so that total peak power demand from the plurality of X-ray imaging systems 82 at the time of the X-ray scan does not exceed a peak power demand of the single X-ray imaging system 82.

FIG. 5 is a schematic diagram illustrating X-ray imaging systems 82 remotely located from each other. As depicted, the X-ray imaging systems 82 are located in different geographical locations. As depicted, one X-ray imaging system 82 is located in geographical location 88 and another X-ray imaging system 82 is located in another geographical location 90 (different from geographical location 88). A different geographical location may include a different building, a different city, a different area, or a different region. Each X-ray imaging system 82 is connected to the same electrical grid 85. Each of the X-ray imaging systems 82 may respectively communicate with each other and/or the computing device 72 in FIG. 3 via a communication network 92 to enable phase shifted operation of X-ray imaging systems 82 so that only a single X-ray imaging system 82 of the plurality of X-ray imaging systems 82 conducts an X-ray scan at a time so that total peak power demand from the plurality of X-ray imaging systems 82 at the time of the X-ray scan does not exceed a peak power demand of the single X-ray imaging system 82.

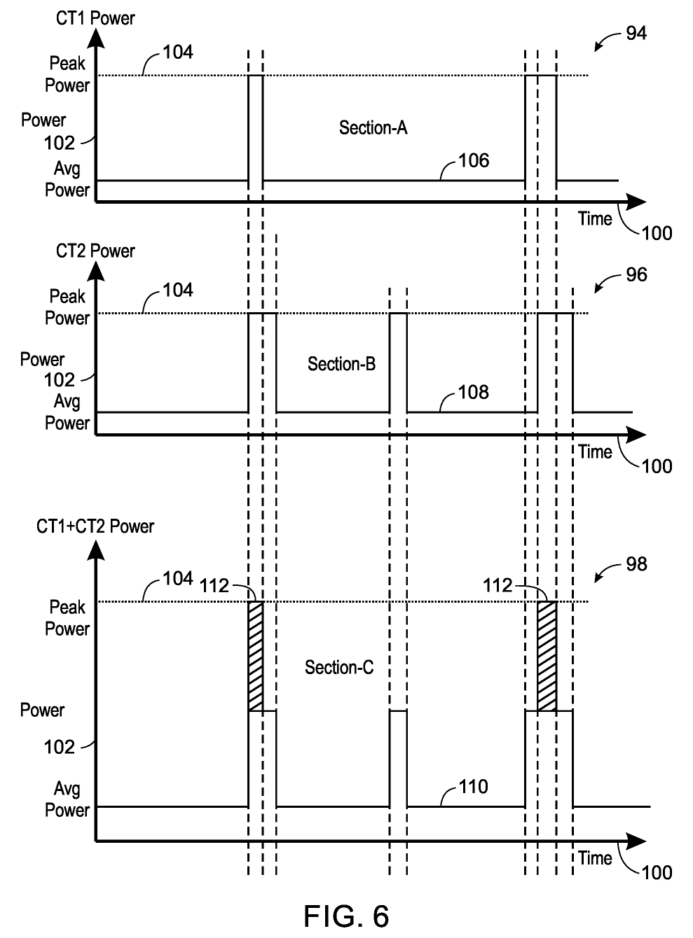

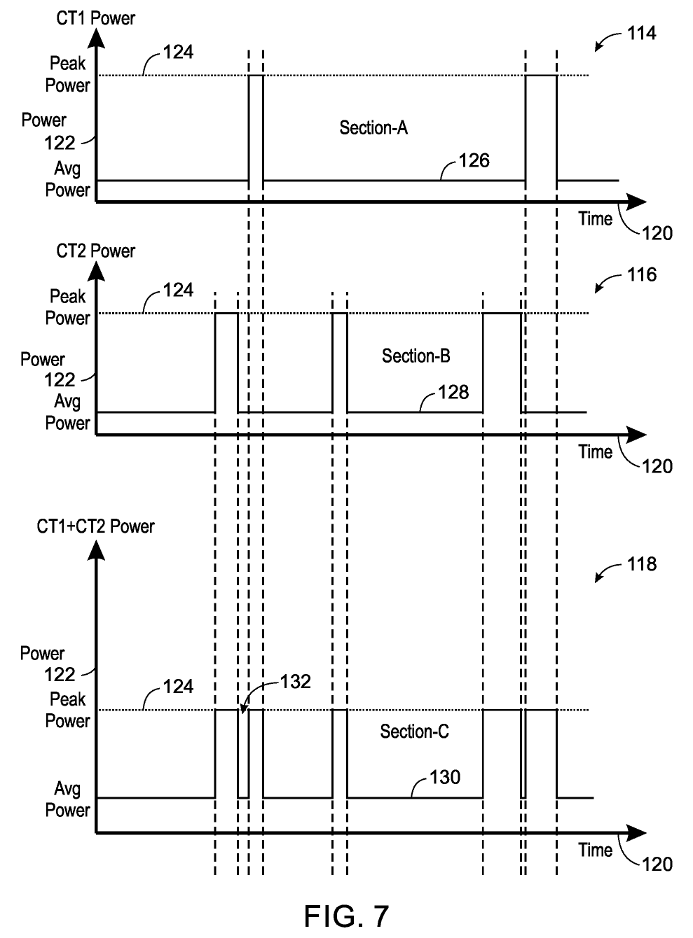

FIG. 6 depicts graphs 94, 96, and 98 illustrating power usage of two different CT imaging systems (e.g., during random operation). Each graph 94, 96, and 98 includes an x-axis 100 representing time and a y-axis 102 representing power. Graph 94 depicts the power usage of a first CT system (CT-1). Graph 96 depicts the power usage of a second CT system (CT-2). Graph 98 depicts the power usage of the first and second CT systems combined. Dashed line 104 represents peak power. Plot 106 in graph 94 represents power usage over time of the first CT system. Plot 108 in graph 96 represents power usage over time of the second CT system. Plot 110 in graph 98 represents power usage over time for both the first and second CT systems. The low points of the plots 106, 108 and 110 represent average power during non scanning period.

A typical CT system is powered from utility grid power as shown in Section-A and Section-B of FIG. 6, where peak power is almost 6 to 9 times the average power. In addition, the duration of peak power (i.e., X-ray scans) is around 20 to 120 seconds. Further, the time interval between the two scans is around 10 to 15 minutes. Considering peak power during a scan for a CT system may be 200 kilo-volt-amperes (kVA), then, if the scans by both the first CT system and the second CT system occur at same time, then a zone 112 can be seen where peak power shall be around 400 kVA as the load to the utility grid as depicted in Section-C of FIG. 6. The peak power of 400 kVA for a short duration (e.g., 60 to 120 seconds) can cause a huge burden on the utility grid as the grid needs to be ready for such a huge, short time power demand from the CT systems when operating together at the same time.

Phase shift operation (e.g., with regard to scheduling) of the CT systems as disclosed herein overcomes this limitation (i.e., each CT system drawing 200 kVA peak power individually from the utility grid at the same time during X-ray scans). FIG. 7 depicts graphs 114, 116, and 118 illustrating power usage of two different CT imaging systems (e.g., during phase shifted operation). Each graph 114, 116, and 118 includes an x-axis 120 representing time and a y-axis 122 representing power. Graph 114 depicts the power usage of a first CT system (CT-1). Graph 116 depicts the power usage of a second CT system (CT-2). Graph 118 depicts the power usage of the first and second CT systems combined. Dashed line 124 represents peak power. Plot 126 in graph 114 represents power usage over time of the first CT system. Plot 128 in graph 116 represents power usage over time of the second CT system. Plot 130 in graph 118 represents power usage over time for both the first and second CT systems. The low points of the plots 126, 128 and 130 represent average power during non scanning period.

In phase shift operation, the first CT system and the second CT system operate in such a way that any given time only one CT system can do an X-ray scan, while the other CT system are in stand-by mode. By doing this, the max power can be limited to 200kVA as shown in Section C of FIG. 7. As depicted, a buffer 132 in time is introduced between scans by the different CT systems. It should be noted that about 10 to 15 minutes in patient setup time by the operator before initiating an actual scan. Hence, it is not possible to achieve the same benefit by using a single CT system.

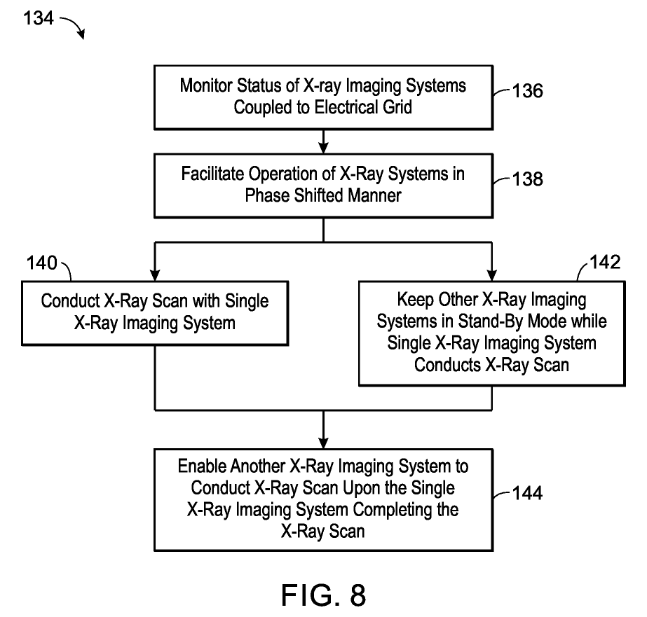

FIG. 8 is a flowchart of a method 134 for phase shifted operation of X-ray imaging systems. Some or all of the steps of the method 134 may be performed by the computing device 50 in FIG. 3.

The method 134 includes monitoring a status of a plurality of X-ray imaging systems coupled to an electrical grid (block 136). The method 134 also includes facilitating operation of the plurality of X-ray imaging systems in a phase shifted manner so that only a single X-ray imaging system of the plurality of X-ray imaging systems conducts an X-ray scan at a time so that total peak power demand from the plurality of X-ray imaging systems at the time of the X-ray scan does not exceed a peak power demand of the single X-ray imaging system (block 138). By operating in the phased shifted manner, multiple X-ray imaging systems (or other equipment) can run without crossing individual peak power limit. In particular, the multiple X-ray imaging systems (connected to the same grid) can run without increasing the peak demand. Operation in the phase shifted manner is operating the multiple X-ray imaging systems in a passed manner (i.e., one at a time or in a time-multiplexed manner). While operating in the phase shifted manner, the method 134 includes conducting an X-ray scan with the single X-ray imaging system (block 140) while keeping the other X-ray imaging systems of the plurality of X-ray imaging systems in a stand-by mode while the single X-ray imaging system is conducting the X-ray scan (block 142). The method 134 also includes enabling another X-ray imaging system of the plurality of X-ray imaging systems to conduct a respective X-ray scan once the single X-ray imaging system completes the X-ray scan (block 144).

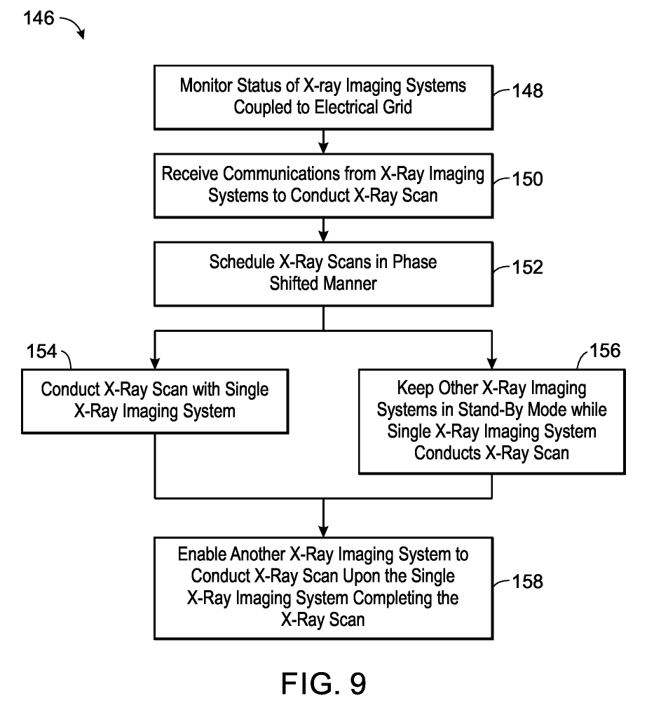

FIG. 9 is a flowchart of a method 146 for phase shifted operation of X-ray imaging systems. Some or all of the steps of the method 146 may be performed by the computing device 50 in FIG. 3.

The method 146 includes monitoring a status of a plurality of X-ray imaging systems coupled to an electrical grid (block 148). The method 146 includes receiving communications from one or more of the plurality of X-ray imaging systems of an intent to conduct a respective X-ray scan (block 150). The method 146 further includes scheduling respective X-ray scans of the plurality of X-ray imaging systems in the phase shifted manner (block 152). In certain embodiments, the respective X-ray scans may be scheduled in the order that the communications of an intent to conduct an X-ray scan are received. In certain embodiments, the respective X-ray scan may be scheduled by priority. For example, an X-ray scan for an emergency case (e.g., life-threatening situation) may be given priority over a non-emergency case (e.g., non-life-threatening situation). The respective X-ray scans are scheduled in the phase shifted manner so that they operate so that only a single X-ray imaging system of the plurality of X-ray imaging systems conducts an X-ray scan at a time so that total peak power demand from the plurality of X-ray imaging systems at the time of the X-ray scan does not exceed a peak power demand of the single X-ray imaging system. By operating in the phased shifted manner, multiple X-ray imaging systems (or other equipment) can run without crossing individual peak power limit. In particular, the multiple X-ray imaging systems (connected to the same grid) can run without increasing the peak demand. Operation in the phase shifted manner is operating the multiple X-ray imaging systems in a passed manner (i.e., one at a time or in a time-multiplexed manner). While operating in the phase shifted manner, the method 146 includes conducting an X-ray scan with the single X-ray imaging system (block 154) while keeping the other X-ray imaging systems of the plurality of X-ray imaging systems in a stand-by mode while the single X-ray imaging system is conducting the X-ray scan (block 156). The method 146 also includes enabling another X-ray imaging system of the plurality of X-ray imaging systems to conduct a respective X-ray scan once the single X-ray imaging system completes the X-ray scan (block 158).

In the case of a hospital (or other healthcare facility) having multiple X-ray imaging systems, the hospital can benefit from operating the X-ray imaging systems in a phase shifted manner to reduce the overall load demand. Operating the X-ray imaging systems in a phase shifted manner significantly reduces electrical infrastructure cost for the hospital as there is no need to install a double size transformer, diesel generator set, and/or a full system uninterruptible power supply. Also, there is no need for the hospital to ask for additional load requirement from the electricity distribution company when installing an additional X-ray imaging system as there will only be a marginal increase in average power but no increase in peak power as demonstrated in FIG. 7. By lowering the effective peak demand, the hospital benefits from a lower running cost by not paying an electricity cost due to a higher demand charge (i.e., if two X-ray imaging systems operated at the same time at the same peak power).

The techniques described above can be scaled up to multiple X-ray imaging systems to get higher benefits. For example, with regard to CT systems, when considering the effective duty cycle of the CT system operation of 120 seconds/900 seconds (2-minute scan duration and 15-minute inter-scan delay), up to 7 CT systems can run in the phase shifted manner without affecting peak power. The CT system number can be more for higher inter-scan time and lower scan duration.

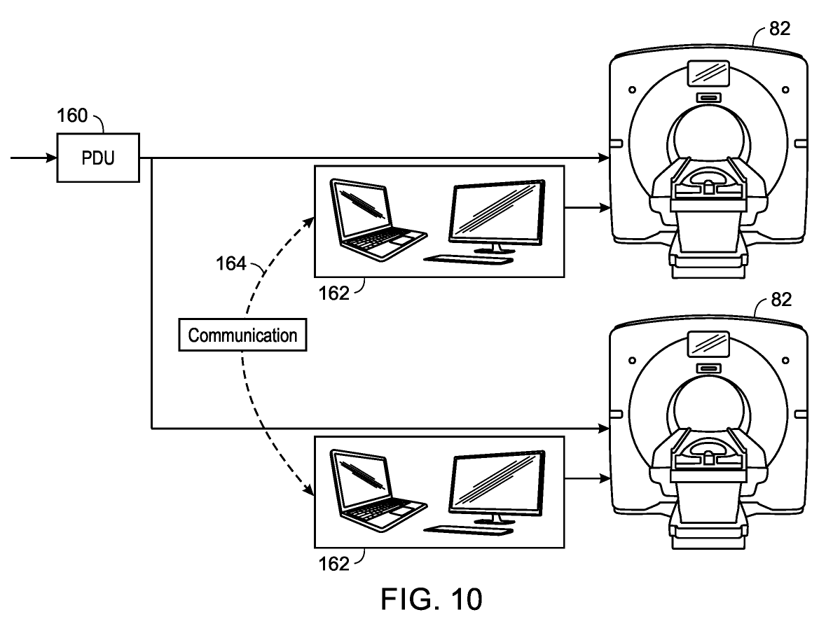

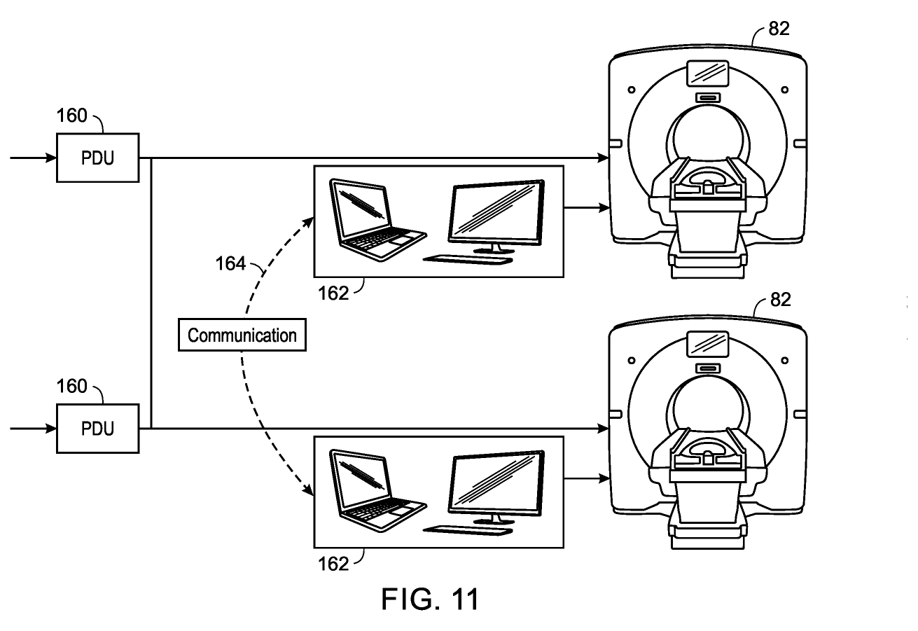

In a typical CT system, the average stand-by power varies between 3 to 5 percent of peak power (i.e., 200 kVA draws about 6 to 10 kVA power during stand-by or no-scan period). But to enable scans, electrical infrastructure and the power distribution unit needs to be designed with 200 kVA power. Hence, the CT system has a power distribution unit in a huge room to power multiple CT systems in terms of average power requirement. In certain embodiments, a single power distribution unit may power multiple CT systems, where CT systems are running in a phase shifted manner. FIG. 10 is a schematic diagram of a single power distribution unit 160 coupled to multiple X-ray imaging systems 82. The X-ray imaging systems 82 are co-located in the same building (e.g., as depicted in FIG. 2). The X-ray imaging systems 82 include respective operating consoles 162 with which they communicate with each other (as indicated by arrow 164) for operating in a phase shifted manner as described above. Alternatively, the co-located X-ray imaging systems 82 may each have a respective power distribution unit 160 as depicted in FIG. 11.

In certain embodiments, for example, when the X-ray imaging systems are located in different geographical locations (e.g., a different building, a different city, a different area, or a different region), a large number (e.g., 2, 3, 4, 5, or more X-ray imaging systems) of respective operating consoles of X-ray imaging systems can communicate over a communication network (cloud-based network or other type of communication network) as depicted in FIG. 5. The X-ray scans , via operation in the phase shifted manner, are prioritized or scheduled in such a way that the utility grid is balanced and the power generation is optimal so that the utility grid can operate at maximum efficiency. Due to this, a lower carbon emission or green initiative by the grid can be achieved. A hospital (or other healthcare facility) having multiple X-ray imaging systems at a same or a different location can participate in the green initiative by operating the X-ray imaging systems more optimally by scheduling the X-ray scans in a phased manner.

In certain embodiments, one network may have up to 7 or 8 or more CT imaging systems (or X-ray imaging systems) based on scan duration and interscan delay. Beyond that another network can be created for additional CT imaging systems (or other X-ray imaging systems). In certain embodiments, the network of CT imaging systems (or other X-ray imaging systems) can be formed of third party machines (with the appropriate communication and scanner control systems).

Technical effects of the disclosed embodiments include enabling a healthcare provider (e.g., hospital) having multiple X-ray imaging systems to reduce their overall load demand. Technical effects of the disclosed embodiments include enabling a healthcare provider to add an additional medical imaging system without adding additional power demand from the utility. Technical effects of the disclosed embodiments include enabling a single power distribution unit to power multiple X-ray imaging systems, which enables a healthcare provider to reduce cost associated with power distribution units. Technical effects of the disclosed embodiments include enabling receiving government incentive by participating in a time-multiplexed operation which helps the utility grid to operate in a more efficient way. Technical effects of the disclosed embodiments include providing a lower footprint by eliminating an additional distribution transformer, diesel generator set, system uninterruptible power supply, and/or power distribution unit.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function]…” or “step for [perform]ing [a function]…”, it is intended that such elements are to be interpreted under 35 U.S.C. 112(f). However, for any claims containing elements designated in any other manner, it is intended that such elements are not to be interpreted under 35 U.S.C. 112(f).

The disclosure also provides support for a computer-implemented method for phase shifted operation of X-ray imaging systems, comprising: monitoring, via a processing system, a status of a plurality of X-ray imaging systems coupled to an electrical grid; and facilitating, via the processing system, operation of the plurality of X-ray imaging systems in a phase shifted manner so that only a single X-ray imaging system of the plurality of X-ray imaging systems conducts an X-ray scan at a time so that total peak power demand from the plurality of X-ray imaging systems at the time of the X-ray scan does not exceed a peak power demand of the single X-ray imaging system. In a first example of the computer-implemented method, the computer-implemented method further comprises keeping, via the processing system, other X-ray imaging systems of the plurality of X-ray imaging systems in a stand-by mode while the single X-ray imaging system is conducting the X-ray scan. In a second example of the computer-implemented method, optionally including the first example, the computer-implemented method further comprises enabling, via the processing system, another X-ray imaging system of the plurality of X-ray imaging systems to conduct a respective X-ray scan once the single X-ray imaging system completes the X-ray scan. In a third example of the computer-implemented method, optionally including one or both of the first and second examples, the plurality of X-ray imaging systems is co-located in a same building. In a fourth example of the computer-implemented method, optionally including one or more or each of the first through third examples, the plurality of X-ray imaging systems is configured to communicate with each other via respective operating consoles of the plurality of X-ray imaging systems to facilitate operation in the phase shifted manner. In a fifth example of the computer-implemented method, optionally including one or more or each of the first through fourth examples, at least two X-ray imaging systems of the plurality of X-ray imaging systems utilize a common power distribution unit. In a sixth example of the computer-implemented method, optionally including one or more or each of the first through fifth examples, at least some X-ray imaging systems of the plurality of X-ray imaging systems are located in different geographical locations. In a seventh example of the computer-implemented method, optionally including one or more or each of the first through sixth examples, the plurality of X-ray imaging systems is configured to communicate with each other via a communication network to facilitate operation in the phase shifted manner. In an eighth example of the computer-implemented method, optionally including one or more or each of the first through seventh examples, the computer-implemented method further comprises receiving, via the processing system, communications from one or more of the plurality of X-ray imaging systems of an intent to conduct a respective X-ray scan. In a ninth example of the computer-implemented method, optionally including one or more or each of the first through eighth examples, the computer-implemented method further comprises scheduling, via the processing system, respective X-ray scans of the plurality of X-ray imaging systems in the phase shifted manner.

The disclosure also provides support for a system for phase shifted operation of X-ray imaging systems, comprising: a memory encoding processor-executable routines; and a processing system comprising one or more processors and configured to access the memory and to execute the processor-executable routines, wherein the processor-executable routines, when executed by the processing system, cause the processing system to: monitor a status of a plurality of X-ray imaging systems coupled to an electrical grid; and facilitate operation of the plurality of X-ray imaging systems in a phase shifted manner so that only a single X-ray imaging system of the plurality of X-ray imaging systems conducts an X-ray scan at a time so that total peak power demand from the plurality of X-ray imaging systems at the time of the X-ray scan does not exceed a peak power demand of the single X-ray imaging system. In a first example of the system, the processor-executable routines, when executed by the processing system, further cause the processing system to keep other X-ray imaging systems of the plurality of X-ray imaging systems in a stand-by mode while the single X-ray imaging system is conducting the X-ray scan. In a second example of the system, optionally including the first example, the processor-executable routines, when executed by the processing system, further cause the processing system to enable another X-ray imaging system of the plurality of X-ray imaging systems to conduct a respective X-ray scan once the single X-ray imaging system completes the X-ray scan. In a third example of the system, optionally including one or both of the first and second examples, the plurality of X-ray imaging systems is co-located in a same building, and wherein the plurality of X-ray imaging systems is configured to communicate with each other via respective operating consoles of the plurality of X-ray imaging systems to facilitate operation in the phase shifted manner. In a fourth example of the system, optionally including one or more or each of the first through third examples, at least two X-ray imaging systems of the plurality of X-ray imaging systems utilize a common power distribution unit. In a fifth example of the system, optionally including one or more or each of the first through fourth examples, at least some X-ray imaging systems of the plurality of X-ray imaging systems are located in different geographical locations, and wherein the plurality of X-ray imaging systems is configured to communicate with each other via a communication network to facilitate operation in the phase shifted manner. In a sixth example of the system, optionally including one or more or each of the first through fifth examples, the processor-executable routines, when executed by the processing system, further cause the processing system to receive communications from one or more of the plurality of X-ray imaging systems of an intent to conduct a respective X-ray scan. In a seventh example of the system, optionally including one or more or each of the first through sixth examples, the processor-executable routines, when executed by the processing system, further cause the processing system to schedule respective X-ray scans of the plurality of X-ray imaging systems in the phase shifted manner.

The disclosure also provides support for a non-transitory computer-readable medium, the non-transitory computer-readable medium comprising processor-executable code that when executed by a processing system comprising one or more processors, causes the processing system to: monitor a status of a plurality of X-ray imaging systems coupled to an electrical grid; and facilitate operation of the plurality of X-ray imaging systems in a phase shifted manner so that only a single X-ray imaging system of the plurality of X-ray imaging systems conducts an X-ray scan at a time so that total peak power demand from the plurality of X-ray imaging systems at the time of the X-ray scan does not exceed a peak power demand of the single X-ray imaging system. In a first example of the non-transitory computer-readable medium, the processor-executable code, when executed by the processing system, further causes the processing system to keep other X-ray imaging systems of the plurality of X-ray imaging systems in a stand-by mode while the single X-ray imaging system is conducting the X-ray scan.

This written description uses examples to disclose the present subject matter, including the best mode, and also to enable any person skilled in the art to practice the subject matter, including making and using any devices or systems and performing any incorporated methods. The patentable scope of the subject matter is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A computer-implemented method for phase shifted operation of X-ray imaging systems, comprising:
monitoring, via a processing system, a status of a plurality of X-ray imaging systems coupled to an electrical grid; and
facilitating, via the processing system, operation of the plurality of X-ray imaging systems in a phase shifted manner so that only a single X-ray imaging system of the plurality of X-ray imaging systems conducts an X-ray scan at a time so that total peak power demand from the plurality of X-ray imaging systems at the time of the X-ray scan does not exceed a peak power demand of the single X-ray imaging system.

2. The computer-implemented method of claim 1, further comprising keeping, via the processing system, other X-ray imaging systems of the plurality of X-ray imaging systems in a stand-by mode while the single X-ray imaging system is conducting the X-ray scan.

3. The computer-implemented method of claim 2, further comprising enabling, via the processing system, another X-ray imaging system of the plurality of X-ray imaging systems to conduct a respective X-ray scan once the single X-ray imaging system completes the X-ray scan.

4. The computer-implemented method of claim 1, wherein the plurality of X-ray imaging systems is co-located in a same building.

5. The computer-implemented method of claim 4, wherein the plurality of X-ray imaging systems is configured to communicate with each other via respective operating consoles of the plurality of X-ray imaging systems to facilitate operation in the phase shifted manner.

6. The computer-implemented method of claim 4, wherein at least two X-ray imaging systems of the plurality of X-ray imaging systems utilize a common power distribution unit.

7. The computer-implemented method of claim 1, wherein at least some X-ray imaging systems of the plurality of X-ray imaging systems are located in different geographical locations.

8. The computer-implemented method of claim 7, wherein the plurality of X-ray imaging systems is configured to communicate with each other via a communication network to facilitate operation in the phase shifted manner.

9. The computer-implemented method of claim 1, further comprising receiving, via the processing system, communications from one or more of the plurality of X-ray imaging systems of an intent to conduct a respective X-ray scan.

10. The computer-implemented method of claim 9, further comprising scheduling, via the processing system, respective X-ray scans of the plurality of X-ray imaging systems in the phase shifted manner.

11. A system for phase shifted operation of X-ray imaging systems, comprising:
a memory encoding processor-executable routines; and
a processing system comprising one or more processors and configured to access the memory and to execute the processor-executable routines, wherein the processor-executable routines, when executed by the processing system, cause the processing system to:
monitor a status of a plurality of X-ray imaging systems coupled to an electrical grid; and
facilitate operation of the plurality of X-ray imaging systems in a phase shifted manner so that only a single X-ray imaging system of the plurality of X-ray imaging systems conducts an X-ray scan at a time so that total peak power demand from the plurality of X-ray imaging systems at the time of the X-ray scan does not exceed a peak power demand of the single X-ray imaging system.

12. The system of claim 11, wherein the processor-executable routines, when executed by the processing system, further cause the processing system to keep other X-ray imaging systems of the plurality of X-ray imaging systems in a stand-by mode while the single X-ray imaging system is conducting the X-ray scan.

13. The system of claim 12, wherein the processor-executable routines, when executed by the processing system, further cause the processing system to enable another X-ray imaging system of the plurality of X-ray imaging systems to conduct a respective X-ray scan once the single X-ray imaging system completes the X-ray scan.

14. The system of claim 11 wherein the plurality of X-ray imaging systems is co-located in a same building, and wherein the plurality of X-ray imaging systems is configured to communicate with each other via respective operating consoles of the plurality of X-ray imaging systems to facilitate operation in the phase shifted manner.

15. The system of claim 14, wherein at least two X-ray imaging systems of the plurality of X-ray imaging systems utilize a common power distribution unit.

16. The system of claim 11, wherein at least some X-ray imaging systems of the plurality of X-ray imaging systems are located in different geographical locations, and wherein the plurality of X-ray imaging systems is configured to communicate with each other via a communication network to facilitate operation in the phase shifted manner.

17. The system of claim 11, wherein the processor-executable routines, when executed by the processing system, further cause the processing system to receive communications from one or more of the plurality of X-ray imaging systems of an intent to conduct a respective X-ray scan.

18. The system of claim 17, wherein the processor-executable routines, when executed by the processing system, further cause the processing system to schedule respective X-ray scans of the plurality of X-ray imaging systems in the phase shifted manner.

19. A non-transitory computer-readable medium, the non-transitory computer-readable medium comprising processor-executable code that when executed by a processing system comprising one or more processors, causes the processing system to:
monitor a status of a plurality of X-ray imaging systems coupled to an electrical grid; and
facilitate operation of the plurality of X-ray imaging systems in a phase shifted manner so that only a single X-ray imaging system of the plurality of X-ray imaging systems conducts an X-ray scan at a time so that total peak power demand from the plurality of X-ray imaging systems at the time of the X-ray scan does not exceed a peak power demand of the single X-ray imaging system.

20. The non-transitory computer-readable medium of claim 19, wherein the processor-executable code, when executed by the processing system, further causes the processing system to keep other X-ray imaging systems of the plurality of X-ray imaging systems in a stand-by mode while the single X-ray imaging system is conducting the X-ray scan.
